(19) United States
(12) Patent Application Publication
(10) Pub. No.: US 2006/0092345 A1
(43) Pub. Date: May 4, 2006

(54) Liquid crystal display apparatus

(76) Inventor: Nobuo Takeuchi, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/251,930

(22) Filed: Oct. 18, 2005

(30) Foreign Application Priority Data
Nov. 4, 2004 (JP) 2004-320893

(51) Int. Cl. G02F 1/1333

(52) U.S. Cl. 349/60

(57) ABSTRACT

A liquid crystal display apparatus comprises a liquid crystal display panel including a display region in which a plurality of display pixels are arrayed, a circuit board which is electrically connected to the liquid crystal display panel, a planar light source device which illuminates the liquid crystal display panel from behind it, and a frame which supports the liquid crystal display panel and the planar light source device, and has a projection extending along a back surface of the planar light source device. The circuit board is arranged on the back surface of the planar light source device, and supported by the projection of the frame at one end thereof. The projection has a step which restrains the circuit board from moving in thickness and surface directions, and a positioning portion which allows a position where the step is formed to be visible from behind the planar light source device.

### CROSS-REFERENCE TO RELATED APPLICATIONS

This application is based upon and claims the benefit of priority from prior Japanese Patent Application No. 2004-320893, filed Nov. 4, 2004, the entire contents of which are incorporated herein by reference.

### BACKGROUND OF THE INVENTION

1. Field of the Invention

The present invention relates to a liquid crystal display apparatus having a frame provided with a projecting portion.

2. Description of the Related Art

Generally, a liquid crystal display apparatus has a liquid crystal display panel on which a plurality of display pixels are arrayed, a circuit board which is electrically connected to the liquid crystal display panel and supplies a driving signal to the panel, a planar light source device which illuminates the liquid crystal display panel from behind it, and a frame which supports the liquid crystal display panel and the planar light source device. The frame has a projection extending along the back surface of the planar light source device. The projection has a step to position the circuit board. The circuit board is connected to the liquid crystal display panel by a flexible board.

When the above liquid crystal display apparatus is assembled, the flexible board is bent so that the circuit board is arranged on the back surface of the planer light source device. One end portion of the circuit board is inserted in a space defined by the projection formed in the frame and the planar light source device, with the result that the circuit board is held in a predetermined position.

In this time, if a too large part of the circuit board is inserted, the circuit board may go beyond the step of the projection and enter an interface between the back surface of the planar light source device and the projection. In this case, the liquid crystal display apparatus may thicken and the display image may deteriorate.

Conventionally, in order to prevent the circuit board from entering the interface between the back surface of the planar light source device and the projection, the following method is proposed: double-faced tapes are adhered to the back surface of the planar light source device and the projection, so that the gap in which the circuit board may enter cannot be formed. Besides, Jpn. Pat. Appln. KOKAI Publication No. 2001-215896 proposed a method, in which a projection formed on a light guide of a planar light source device is engaged with a positioning hole formed in a circuit board.

However, the above method of adhering double-faced tapes to the back surface of the planar light source device and the projection may cause twist of the reflecting sheet, resulting in deterioration of the display image. On the other hand, in the method of positioning the circuit board disclosed in the aforementioned publication, since the projection of the light guide is inserted through the positioning hole in the thickness direction of the circuit board, the thickness of the liquid crystal display apparatus may increase by the projection, which projects from the back surface of the circuit board.

### BRIEF SUMMARY OF THE INVENTION

The present invention was made to solve the problems of the prior art described above. An object of the present invention is to provide a liquid crystal display apparatus, which prevents the display image from deteriorating and easily positions the circuit board at a predetermined position without increasing the thickness of the liquid crystal display apparatus.

According to an aspect of the present invention, there is provided a liquid crystal display apparatus comprising: a liquid crystal display panel including a display region in which a plurality of display pixels are arrayed; a circuit board which is electrically connected to the liquid crystal display panel; a planar light source device which illuminates the liquid crystal display panel from behind it; and a frame which supports the liquid crystal display panel and the planar light source device, and has a projection extending along a back surface of the planar light source device, wherein the circuit board is arranged on the back surface of the planar light source device, and supported by the projection of the frame at one end thereof, and the projection has a step which restrains the circuit board from moving in thickness and surface directions, and a positioning portion which allows a position where the step is formed to be visible from behind the planar light source device.

According to the present invention, it is possible to provide a liquid crystal display apparatus, which prevents the display image from deteriorating and easily positions the circuit board at a predetermined position without increasing the thickness of the liquid crystal display apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view schematically showing a liquid crystal display apparatus according to an embodiment of the present invention;

FIG. 2 is an exploded perspective view schematically showing the planar light source device shown in FIG. 1;

FIG. 3 is a plan view of the projection of the frame of the liquid crystal display apparatus shown in FIG. 1 as viewed from the back surface side of the planer light source device;

FIG. 4 is a cross-sectional view of the liquid crystal display apparatus shown in FIG. 3 taken along the line IV-IV;

FIG. 5 is a plan view of the projection of the frame of a liquid crystal display apparatus according to another embodiment of the present invention as viewed from the back surface side of the planer light source device; and

FIG. 6 is a cross-sectional view of the liquid crystal display apparatus shown in FIG. 5 taken along the line VI-VI.

### DETAILED DESCRIPTION OF THE INVENTION

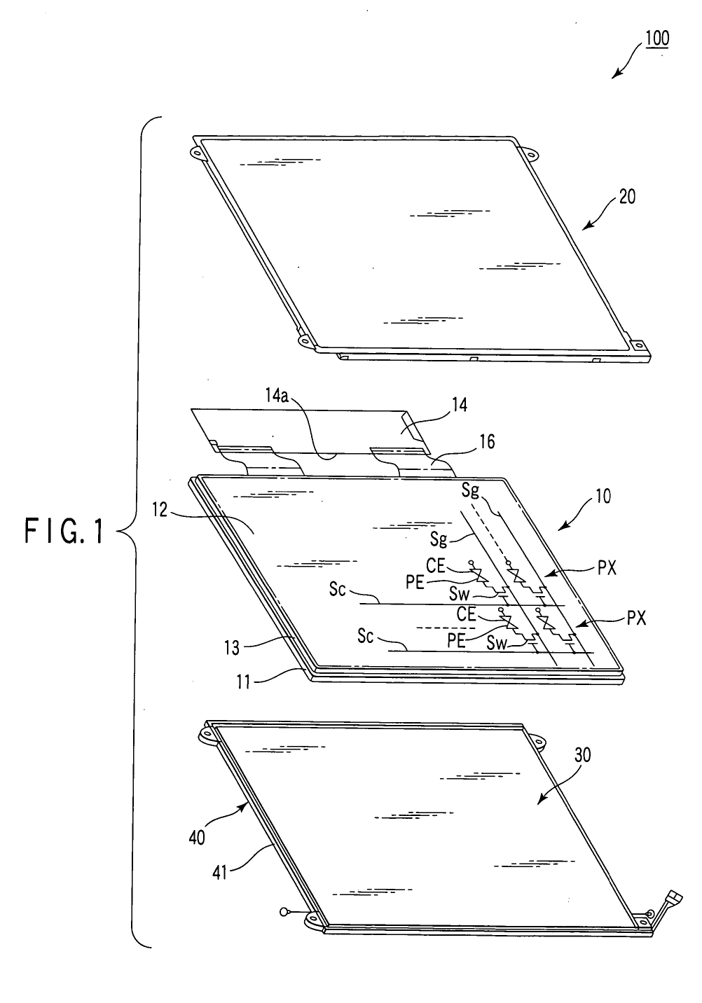

A liquid crystal display apparatus according to an embodiment of the present invention will be described with reference to the accompanying drawings. FIG. 1 is an exploded perspective view schematically showing a liquid crystal display apparatus 100 according to the embodiment. As shown in FIG. 1, the liquid crystal display apparatus 100 comprises a liquid crystal display panel 10 which is approximately rectangular; a planar light source device 30 which illuminates the liquid crystal display panel 10 from behind it; a frame 40 which supports the liquid crystal display panel 10 and the planar light source device 30; and a bezel cover 20 which is attached to the frame 40 and holds the peripheral portion of the liquid crystal display panel 10.

The liquid crystal display panel 10 comprises an array substrate 11 and a counter substrate 13, which are arranged opposite to each other. A liquid crystal layer is sandwiched between the array substrate 11 and the counter substrate 13. A polarizing plate is attached to the outer surface of each of the array substrate 11 and the counter substrate 13.

The liquid crystal display panel 10 has a display section 12, which corresponds to a display region to display images. The array substrate 11 has, in the display section 12, a plurality of pixels PX arranged in a matrix form, a plurality of scanning lines Sc extending in a row direction of pixels PX, a plurality of signal lines Sg extending in a column direction of the pixels PX, and a plurality of switching elements Sw provided in the respective pixels PX. In each pixel PX, the switching element SW is arranged near the intersection between the scanning line Sc and the signal line Sg. The switching element Sw comprises a thin film transistor (TFT) having, for example, a polysilicon semiconductor layer.

The array substrate 11 and the counter substrate 13 are arranged such that a pixel electrode PE and a counter electrode CE of each pixel PX face each other, and form a gap therebetween. The liquid crystal layer is formed of a liquid crystal composition sealed in the gap between the array substrate 11 and the counter substrate 13.

A rectangular flat circuit board 14, which supplies a driving signal to the liquid crystal display panel 10, is electrically connected to a side end of the liquid crystal display panel 10 via a flexible board 16 having an elongated rectangular flat shape.

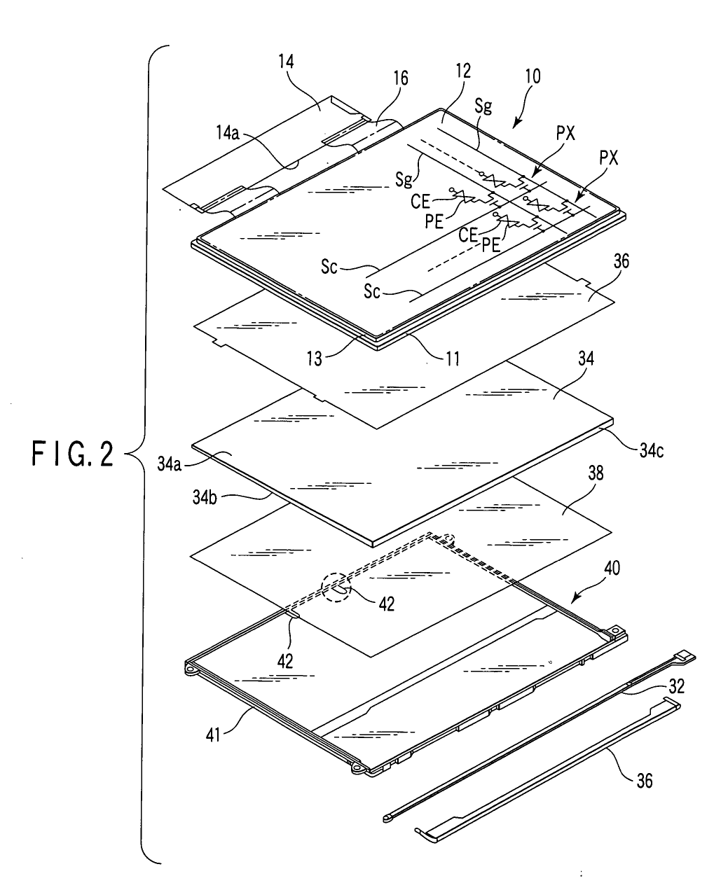

FIG. 2 is an exploded perspective view of the planar light source device 30 shown in FIG. 1. As shown in FIG. 2, the planar light source device 30 has a cold cathode fluorescent tube 32 serving as a light source, a light guide 34 which converts light emitted from the cold cathode fluorescent tube 32 to planar light and guides it toward the liquid crystal display panel 10, and a reflector 36 serving as a reflecting body which reflects the light emitted from the cold cathode fluorescent tube 32 toward a light entrance surface 34c of the light guide 34.

The light guide 34 is formed of resin, which is translucent. The light guide 34 has a light exit surface 34a, from which the light entered through the light entrance surface 34c exits, and a counter surface 34b opposing to the light exit surface 34a. The light guide 34 has a wedge shape, whose thickness becomes gradually smaller along a normal to the light entrance surface 34c as the distance from the light entrance surface 34c increases. With this shape, space for the driver circuit board 14 is provided on the back side of the planar light source device 30.

An optical sheet 36 is arranged on the light exit surface 34a of the light guide 34. The optical sheet 36 imparts predetermined optical characteristics to the planar light that exits from the light exit surface 34a of the light guide 34. For example, the optical sheet 36 may be a light collecting sheet which collects the light that exits from the light guide 34, or a light diffusing sheet which diffuses the exit light. A reflecting sheet 38, as an optical sheet, is arranged on the counter surface 34b of the light guide 34. The reflecting sheet 38 reflects the light, which is leaked through the counter surface 34b of the light guide 34, so as to return the light towards the light guide 34.

The frame 40 has a rectangular shape corresponding to the liquid crystal display panel 10. It has four straight frame portions 41 respectively corresponding to the sides of the panel 10. Two projections 42 are formed on one of the frame portions 41 of the frame 40, for example, a long side frame portion 41.

The reflecting sheet 38, the light guide 34 and the optical sheet 36 are stacked as described above and held in the frame 40. The liquid crystal display panel 10 is held on the optical sheet 36, and the bezel cover 20 is attached to the frame 40 over the liquid crystal display panel 10. The flexible board 16 is bent, so that the circuit board 14 is arranged on the back surface of the planar light source device 30. In this state, a side 14a of the circuit board 14, which is connected to the flexible board 16, is supported by the projections 42 of the frame 40 in positions to which the flexible board 16 is not connected.

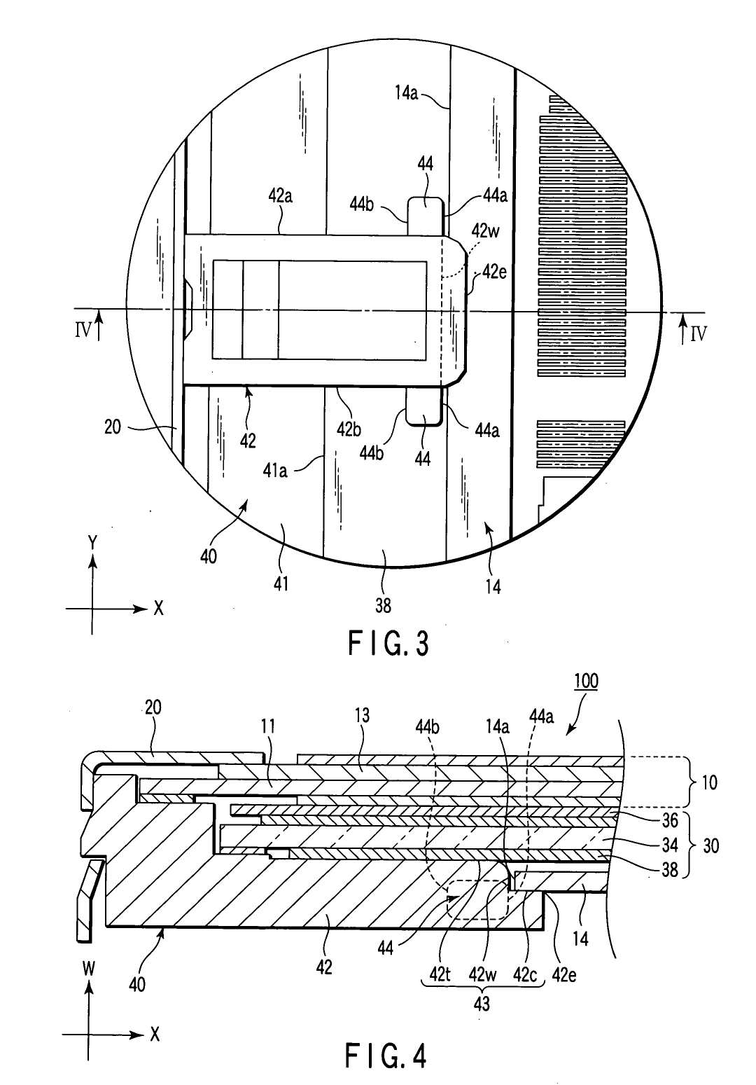

FIG. 3 is a plan view of one of the projections 42 of the frame 40 as viewed from the back surface side of the planer light source device 30, and FIG. 4 is a cross-sectional view of the liquid crystal display apparatus shown in FIG. 3 taken along the line IV-IV. In the following one of the projections 42 will be described as a representative. As shown in FIGS. 3 and 4, the frame 40 has the projection 42 extending along the back surface of the planar light source device 30. As shown in FIG. 4, the projection 42 has a step 43 in its top end portion. The step 43 is formed on that surface of the projection 42 which faces the circuit board 14. The circuit board 14 is held between the step 43 and the back surface of the planar light source device 30.

The step 43 has a first surface 42t which supports the planar light source device 30, a second surface 42c which supports the circuit board 14 and a step height surface 42w extending substantially parallel to the thickness direction (W direction) of the liquid crystal display apparatus 100 and connecting the first surface 42t and the second surface 42c. The length of the step height surface 42W in the thickness direction (W direction) is greater than the thickness of the circuit board 14. Therefore, the step 43 restrains the circuit board 14 inserted between the back surface of the planar light source device 30 and the second surface 42c from moving in the thickness direction (W direction) and the surface direction (X direction). In other words, the position of the circuit board 14 is restricted by the back surface of the planar light source device 30 and the portion of the projection 42 from an edge 42e to the step height surface 42w.

The thickness direction of the liquid crystal display apparatus 100 and the circuit board 14 is the same as the height direction of the step 43. These directions correspond to the W direction shown in FIG. 4.

As shown in FIG. 3, the projection 42 has a first side surface 42a and a second side surface 42b, which extend from the frame portion 41 in a direction (X direction) substantially perpendicular to a side 41a extending in the longitudinal direction of the frame portion 41. The projection 42 also has positioning projections 44.

The positioning projections 44 are substantially rectangular, and extend from the first side surface 42a and the second side surface 42b of the projection 42 in a direction (Y direction) substantially parallel to the side 41a. Each of the positioning projections 44 has a first side surface 44a extending from the first side surface 42a or the second side surface 42b of the projection 42, and a second side surface 44b opposite to the first side surface 44a. The positioning projections 44 are arranged such that the first side surfaces 44a are aligned with the step height surface 42w.

The X direction is substantially perpendicular to the side 41a of the frame 41 on which the positioning projection 44 is formed. The Y direction is the longitudinal direction of the frame portion 41 and substantially perpendicular to the X direction.

Because the positioning projections 44 are formed in the projection 42 of the frame 40 as described above, the position of the step height face 42w of the projection 42 is visible from behind the planar light source device 30. Therefore, when the circuit board 14 is inserted between the back surface of the planar light source device 30 and the step 43 of the projection 42 with reference to the first side surfaces 44a of the positioning projections 44, the circuit board 14 is inserted between the second surface 42c and the reflecting sheet 38. Thus, the circuit board 14 is prevented from entering between the first surface 42t of the projection 42 and the reflecting sheet 38. Consequently, the circuit board 14 can be positioned in a predetermined position without increasing the thickness of the liquid crystal display apparatus 100, and deterioration of the display image can be prevented.

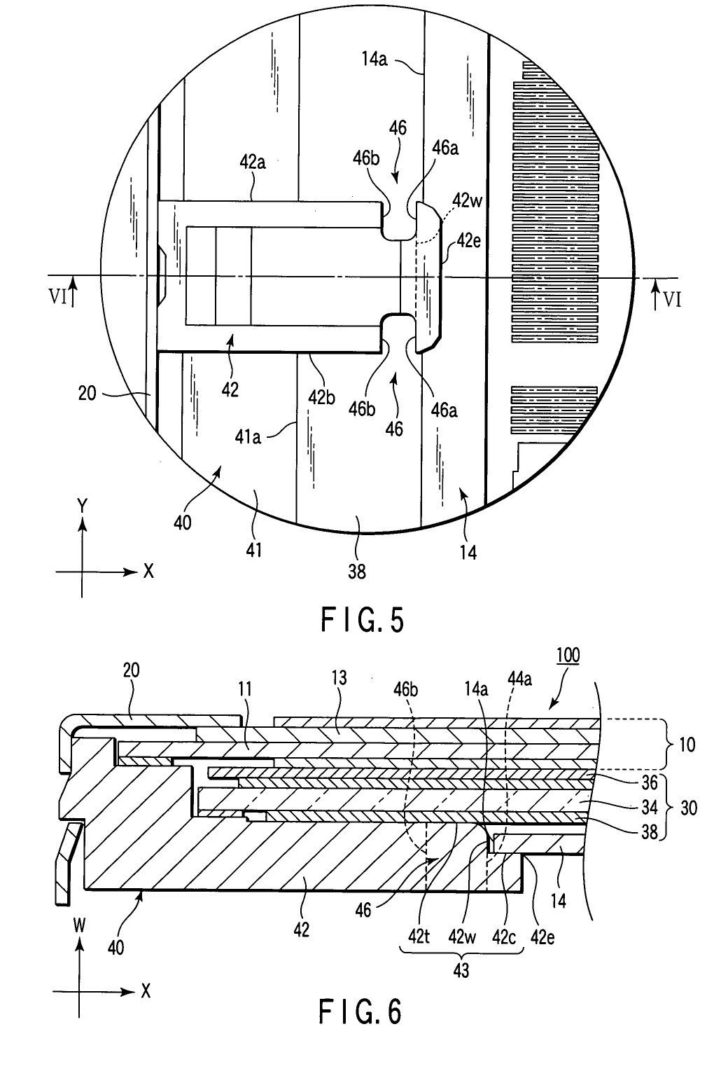

FIG. 5 is a plan view of the projection 42 of a liquid crystal display apparatus according to another embodiment of the present invention as viewed from the back surface side of the planer light source device 30. FIG. 6 is a cross-sectional view of the liquid crystal display apparatus 100 shown in FIG. 5 taken along the line VI-VI.

As well as the embodiment shown in FIGS. 3 and 4, the frame 40 shown in FIGS. 5 and 6 has the projection 42 extending along the back surface of the planar light source device 30. The projection 42 has, in its top end portion, a step 43 which restrains the circuit board 14 from moving in the thickness direction (W direction) and the surface direction (X direction) of the circuit board 14. The step 43 has a first surface 42t which supports the planar light source device 30, a second surface 42c which supports the circuit board 14 and a step height surface 42w extending substantially parallel to the thickness direction (W direction) of the liquid crystal display apparatus 100 and connecting the first surface 42t and the second surface 42c.

As shown in FIG. 5, the projection 42 of this embodiment has a first side surface 42a and a second side surface 42b, which extend from the frame portion 41 of the frame 40 in a direction (X direction) substantially perpendicular to a side 41a of the frame portion 41. The projection 42 also has positioning cuts 46, which serve as positioning portions. Each of the positioning cuts 46 has a first side surface 46a extending from the first side surface 42a or the second side surface 42b of the projection 42, and a second side surface 46b opposite to the first side surface 46a.

The positioning cuts 46 extend from the first side surface 42a and the second side surface 42b of the projection 42 in a direction (Y direction) substantially parallel to the side 41a, which extends in the longitudinal direction of the frame 40. The positioning cuts 46 are arranged such that the first side surfaces 46a are aligned with the step height surface 42w.

Because the positioning cuts 46 are formed in the projection 42 as described above, as well as the embodiment shown in FIGS. 3 and 4, the circuit board 14 is prevented from entering between the first surface 42t of the projection 42 and the reflecting sheet 38. Consequently, the circuit board 14 can be positioned in a predetermined position without increasing the thickness of the liquid crystal display apparatus, and deterioration of the display image can be prevented.

The present invention is not limited to the above embodiments, and the structural elements can be modified when practiced, without departing from the scope of the invention.

For example, in the above embodiments, the positioning projections 44 or the positioning cuts 46 are formed in the positions where the side surfaces 44a or 46a are aligned with the step height surface 42w. However, the positioning projections 44 or the positioning cuts 46 may be formed between the step height surface 42w and the top end of the projection 42. In this case, for example, the positioning projections 44 are arranged such that the side surfaces 44b opposite to the side surfaces 44a are aligned with the step height surface 42w.

The positioning projections 44 and the positioning cuts 46 are not limited to the above positions, but may be arranged such that the step height surface 42w is located at least between the surface 44a or 46a and the surface 44b or 46b. In this case also, the position of the step height surface 42w of the projection 42 is visible from the back of the planar light source device 30. The same advantage as that in the above embodiments can be obtained.

Further, although the positioning projections 44 or the positioning cuts 46 are substantially rectangular in the above embodiments, they may have any shape, which has a surface or side extending along the Y direction in alignment with the step height surface 42w.

The present invention can be variously modified by suitably combining a plurality of elements of the embodiments disclosed above. For example, some of the elements may be deleted from all elements of the embodiment. Furthermore, elements of the different embodiments may be suitably combined. In the embodiments described above, the positioning projections 44 or the positioning cuts 46 are formed on both sides of the step 43 extending in the Y direction. However, the positioning projection 44 or the positioning cut 46 may be formed on either side of the step 43.

Furthermore, one projection 42 may have both the positioning projections 44 and the positioning cuts 46. The surfaces 44a and 46a may be formed on one side so that they align with the step height surface 42w, while the surfaces 44b and 46b may be formed on the other side so that they align with the step height surface 42w. In this case also, the same advantage as that in the above embodiments can be obtained.

What is claimed is:

1. A liquid crystal display apparatus comprising:
a liquid crystal display panel including a display region in which a plurality of display pixels are arrayed;
a circuit board which is electrically connected to the liquid crystal display panel;
a planar light source device which illuminates the liquid crystal display panel from behind it; and
a frame which supports the liquid crystal display panel and the planar light source device, and has a projection extending along a back surface of the planar light source device, wherein
the circuit board is arranged on the back surface of the planar light source device, and supported by the projection of the frame at one end thereof, and
the projection has a step which restrains the circuit board from moving in thickness and surface directions, and a positioning portion which allows a position where the step is formed to be visible from behind the planar light source device.

2. The liquid crystal display apparatus according to claim 1, wherein the step of the projection is formed on a surface of the projection that faces the circuit board, so that the circuit board is restrained between the step and the back surface of the planar light source device.

3. The liquid crystal display apparatus according to claim 2, wherein the step is formed in a top end portion of the projection, and the step has a step height surface extending in a direction substantially perpendicular to the back surface of the planar light source device, and an end surface facing the circuit board and extending from an edge of the top end portion to the step height surface.

4. The liquid crystal display apparatus according to claim 3, wherein the circuit board is restrained between the end surface and the back surface of the planar light source device.

5. The liquid crystal display apparatus according to claim 1, wherein the positioning portion is formed in either side of the projection along a direction in which the step extends.

6. The liquid crystal display apparatus according to claim 1, wherein the positioning portion comprises a positioning projection, which projects from the projection.

7. The liquid crystal display apparatus according to claim 6, wherein the positioning projection has a surface which extends substantially parallel to a longitudinal direction of a frame portion of the frame in which the projection is formed, and the surface is aligned with a plane of the step that is substantially parallel to a thickness direction of the projection.

8. The liquid crystal display apparatus according to claim 1, wherein the positioning portion comprises a positioning cut, which is formed in the projection.

9. The liquid crystal display apparatus according to claim 8, wherein the positioning cut has a surface which extends substantially parallel to a longitudinal direction of a frame portion of the frame in which the projection is formed, and the surface is aligned with a plane of the step that is substantially parallel to a thickness direction of the projection.

10. The liquid crystal display apparatus according to claim 1, wherein the circuit board is electrically connected to the liquid crystal display panel by a flexible board, which is bent so that the circuit board is arranged on the back surface of the planar light source device and supported by the projection in a position to which the flexible board is not connected.
